(19) United States
(12) Patent Application Publication
(10) Pub. No.: US 2013/0203280 A1
(43) Pub. Date: Aug. 8, 2013

(54) INTERFACE CONNECTOR

(71) Applicants: Daniel Greub, St. Gallen (CH); Michael Lothar Völker, Sax (CH); Urs Schlaepper, Herisau (CH)

(72) Inventors: Daniel Greub, St. Gallen (CH); Michael Lothar Völker, Sax (CH); Urs Schlaepper, Herisau (CH)

(73) Assignee: Huber+Suhner AG, Herisau (CH)

(21) Appl. No.: 13/635,619

(22) PCT Filed: Mar. 10, 2011
(86) PCT No.: PCT/EP11/53579

§ 371 Date: Jan. 2, 2013

(30) Foreign Application Priority Data
Mar. 18, 2010 (CH) 00411/10

(51) Int. Cl. H01R 13/625

(52) U.S. Cl. CPC H01R 13/625
USPC 439/350

(57) ABSTRACT

The invention relates to an interface connector (1) having a socket (3) and a plug part (2) that can be mechanically operationally connected to the socket (3) by means of a locking sleeve (10). The plug part comprises a holder (4) for receiving at least one internal connector (5). The holder (4) is slidably disposed with respect to the locking sleeve (10) and is operationally connected to same by means of a first and a second adjuster (15, 24). When the plug part (2) is mechanically operationally connected to the socket (3), the internal connector (5) is positioned by the first adjuster (15) relative to a connector counterpart (21) disposed on the socket (3). After reaching a defined end position, the internal connector (5) is fixed relative to the connector counterpart (21) by the second adjuster (24).

### BACKGROUND OF THE INVENTION

1. Field of the Invention

The invention lies within the field of connector technology and relates to an interface connector for connecting one or more connectors arranged internally.

2. Discussion of Related Art

For example in mobile communication systems, there is a need in the outdoor area to connect one or more connectors to corresponding counterpieces. Various interface connectors are known from the prior art. An interface is to be understood in the present case to mean a connector that is suitable for receiving at least one second connector in its interior. The second connector is inserted into the first connector (the interface connector) and is operatively connected to its counterpiece by means of said first connector. The interface connector is used to protect and discharge the second connector and to transfer the mechanical force, or to seal the second connector with respect to environmental influences.

U.S. Pat. No. 7,338,214BA by Tyco was published in 2008 and presents an interface for connecting different types of connectors, including LC connectors. The connectors are inserted into a clip, which is in turn inserted into an adapter. The adapter is then inserted into an outer housing, which can be operatively connected via a cap nut via a bayonet closure to a counterpiece. The interface has a relatively complicated structure.

U.S. Pat. No. 6,884,099B by Agilent Technologies Inc. was published in 2005 and is directed to a BNC connector, which is embedded in an outer housing and can be operatively connected via a lever.

U.S. Pat. No. 7,338,214 by Tyco Electronics Corporation was published in March 2008 and concerns a method and a device for sealing a plug part of a cable entry for optical connectors. Two LC connectors can be arranged fixedly in an outer housing of the plug part via an adapter. This device has the disadvantages described above.

EP1018660 by Delphi Technologies Inc. was published in July 2000 and presents a connection device for coupling an optical waveguide to an opto-electrical converter. The device has a socket, which can be fastened on a printed circuit board. A cable-side connector part can be snap-fitted into an opening, in which it is held by means of a spring.

EP0154781 by AMP Incorporated was published in 1985 and presents an optical connector arrangement comprising a housing-side flange part, to which an optical connector can be connected from either side. The two connectors are aligned coaxially with one another in the assembled state and enter into operative connection with one another.

US2007/0047877 by Tyco Electronics Corporation was published in 2007 and presents an interface for receiving a plurality of LC connectors. These are inserted into an adapter, which is in turn inserted into one of two interface parts. The first and second interface parts are operatively connected to one another via a bayonet closure. Inside, the LC connectors are at the same time operatively connected to compatible counterpieces.

EP1170830A1 by Delphi Technologies Inc. was published in 2002 and presents an electrical connector for use in a motor vehicle. A plug-in movement in translation is transformed into an automatic securing movement via what is known as a “drive element”.

Further publications that present connectors are EP1043612 (two identical connectors without an interface), EP1067416 (optical connectors with internal, resiliently mounted ferrule terminals for optical waveguides) and US2009/0060420 (hybrid connector with axially resiliently mounted inner workings).

The connectors known from the prior art are relatively difficult to assemble in the field and have a complicated structure. A further disadvantage lies in the fact that the inner workings of the conventional connectors is subjected to considerable stresses in the assembled state, for example as a result of severe temperature fluctuations or mechanical forces.

### SUMMARY OF THE INVENTION

An object of the invention is to present an interface connector that does not have the problems associated with the prior art.

The object is achieved by the device defined in the claims.

In one embodiment, the invention relates to an interface connector having an outer plug part, which is suitable for receiving one or more inner connectors. The outer plug part is designed such that it can be operatively connected to a counterpiece of corresponding design. For example, the counterpiece may be a socket to be fastened to a housing or a second plug part to be fastened to a cable.

A cable-side interface connector generally has a holder for receiving at least one inner connector. If necessary, the connectors can be integrated in the holder in a fixed or exchangeable manner. The holder likewise has operative connection means for this purpose, which can be operatively connected to the operative connection means of the connectors. In one embodiment, the socket has a flange suitable for assembly on a housing of an appliance. The flange has coupling means for strain relief and an assembly opening for one or more cables to be connected. Depending on the embodiment, the coupling means may be a thread or a bayonet closure or a snap-in device.

In one embodiment, the invention relates to an interface connector having a socket or a second cable-side connector part and a plug part that can be mechanically operatively connected to the socket via a locking sleeve. Threads or bayonet closures are generally suitable operative connection means. Secondary locking elements, for example in the form of snap-in hooks, which cooperate with the socket, may be provided so as to avoid undesired shifting of the locking sleeve.

The plug part has a holder for receiving at least one internal connector. The holder can be designed such that locking elements of the inserted connectors are deactivated selectively. For example, when the connector is inserted a protruding locking arm is pressed down and is fixed such that it is no longer effective. The locking function is taken over by other elements.

The holder is arranged displaceably with respect to the locking sleeve, at least in one direction, and is operatively connected thereto via a first and a second adjuster. When the plug part is mechanically operatively connected to the socket, the internal connector is first positioned by the first adjuster with respect to a connector counterpiece arranged on the socket. Once a defined end position has been reached, the internal connector is fixed with respect to the connector counterpiece by the second adjuster. The first adjuster, which produces a mechanical operative connection between the locking sleeve and the holder, may comprise a control pin, which engages in a guide groove in such a way that the holder is displaced in the direction of an axis of rotation relative to the locking sleeve by rotating the locking sleeve about the axis of rotation. The guide groove may have a plurality of segments, in such a way that the internal connector is moved according to the rotation of the guide sleeve. The guide groove is advantageously formed on a cylindrical outer face of a control part, which is operatively connected to the locking sleeve. Depending on the design, the guide groove may also be formed on an outer face of the holder. For example, to relieve a spring, the guide groove may have a plurality of segments and may be V-shaped for example. In one embodiment, the second adjuster has a segmented inner thread and a segmented outer thread, which engage in one another at a specific angle of rotation to fix the holder with respect to the socket. The segmented threads are advantageously designed such that they can engage in one another at different axial positions. A spring may be arranged between the holder and the locking sleeve so that the holder is displaceable against the force of this spring for positioning purposes. In particular with interface connectors designed for long operating periods, the first adjuster is advantageously designed such that the spring is relieved once the locking sleeve has been assembled on the socket and once the internal connector has been fixed with respect to its connector counterpiece. The connector is thus less sensitive to external influences, such as severe temperature fluctuations. The spring can be used to transfer the rotation of the locking sleeve onto a front part, which is used to displace the holder in the axial direction. The spring is formed so as to be sufficiently torsionally rigid for this purpose. The at least one internal connector may also be integrated fixedly in the holder if necessary. The locking sleeve may have a retaining thread, by means of which it is operatively connectable to the socket. The retaining thread may have the same pitch as the segmented thread of the second adjuster. Where at least one internal connector is provided, this may be an optical and/or electrical connector.

A method for connecting a plug part to a socket generally comprises the following method steps:

(a) where necessary, insertion of at least one inner connector into a holder;

(b) alignment and fitting of the locking sleeve into the socket as far as a first stop;

(c) rotation of the locking sleeve with respect to the socket so that the holder with the at least one internal connector is displaced in the axial direction by the first adjuster and the at least one internal connector is slid into the connector counterpiece;

(d) once a defined position of the at least one internal connector with respect to the connector counterpiece has been reached, further rotation of the locking sleeve with respect to the socket so that the first adjuster is released by the second adjuster, which causes the at least one internal connector to be fixed with respect to the connector counterpiece by the second adjuster.

### BRIEF DESCRIPTION OF THE DRAWINGS

The invention will be explained in greater detail on the basis of embodiments shown in the following figures, in which:

FIG. 1 shows an interface connector at an angle from behind and above;

FIG. 2 shows the interface connector at an angle from the front and above;

FIG. 3 shows the interface connector in an exploded illustration;

FIG. 4 shows the interface connector in a partly cut-away illustration;

FIG. 5 shows the interface connector in plan view;

FIG. 6 shows the interface connector in a sectional illustration;

FIG. 7 shows part of the inner workings of the interface connector.

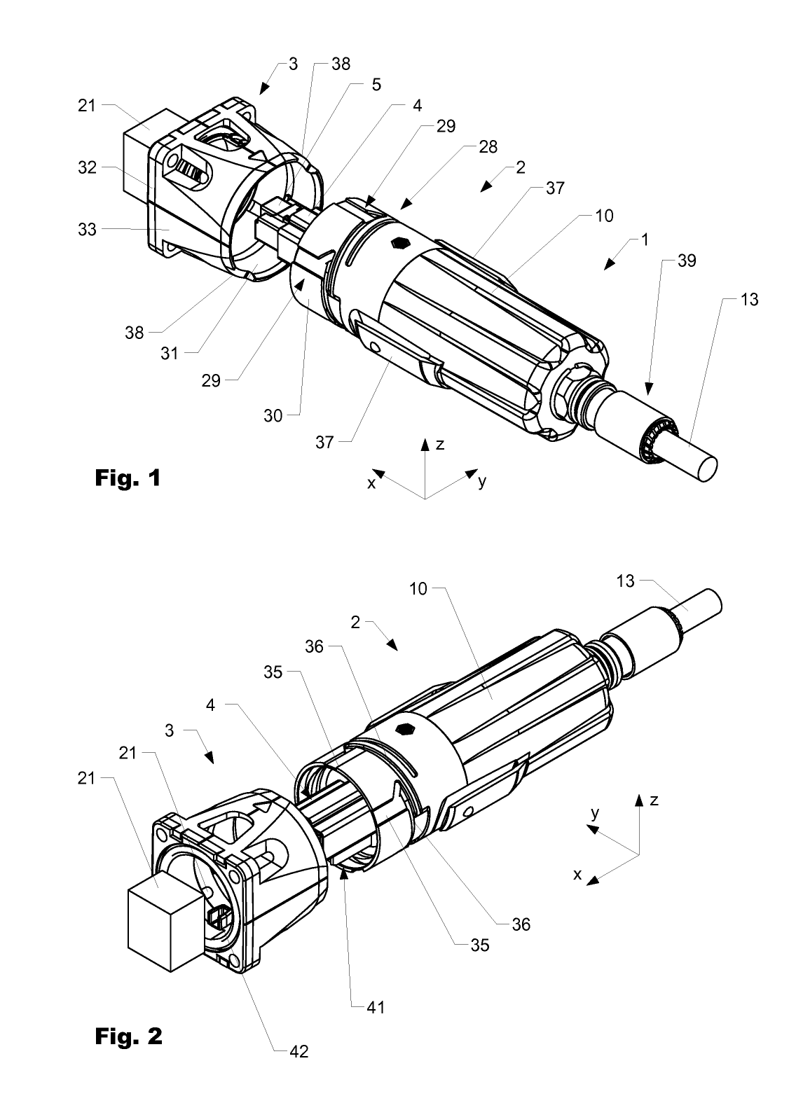

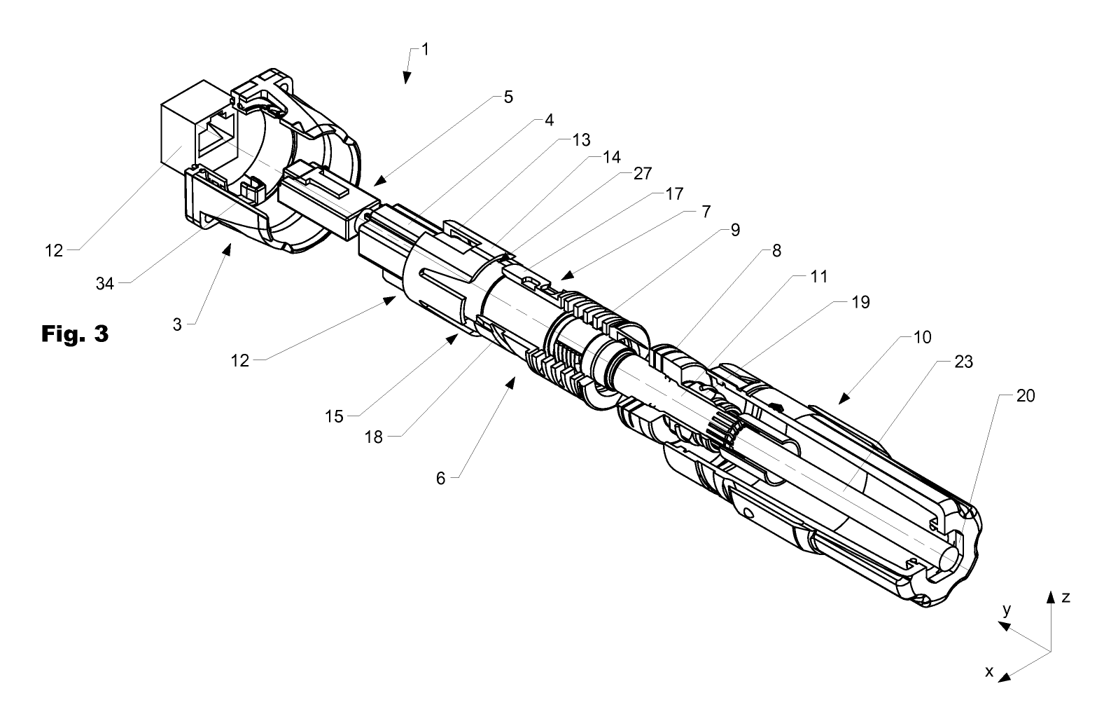

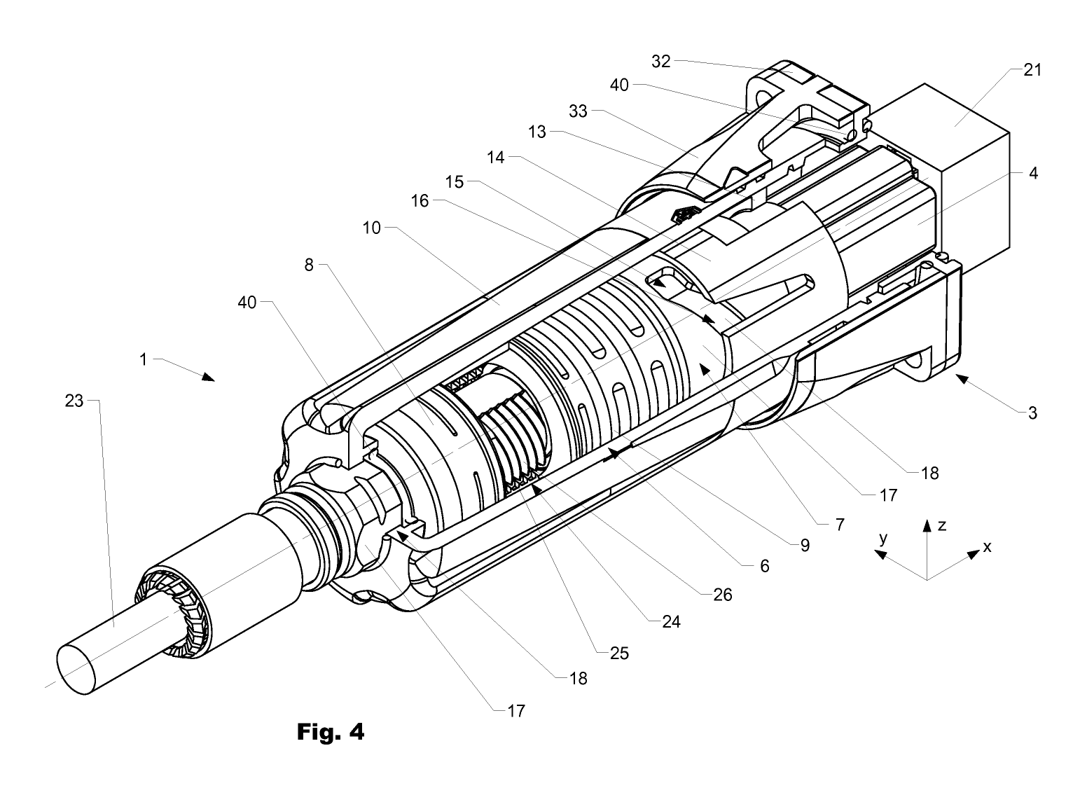

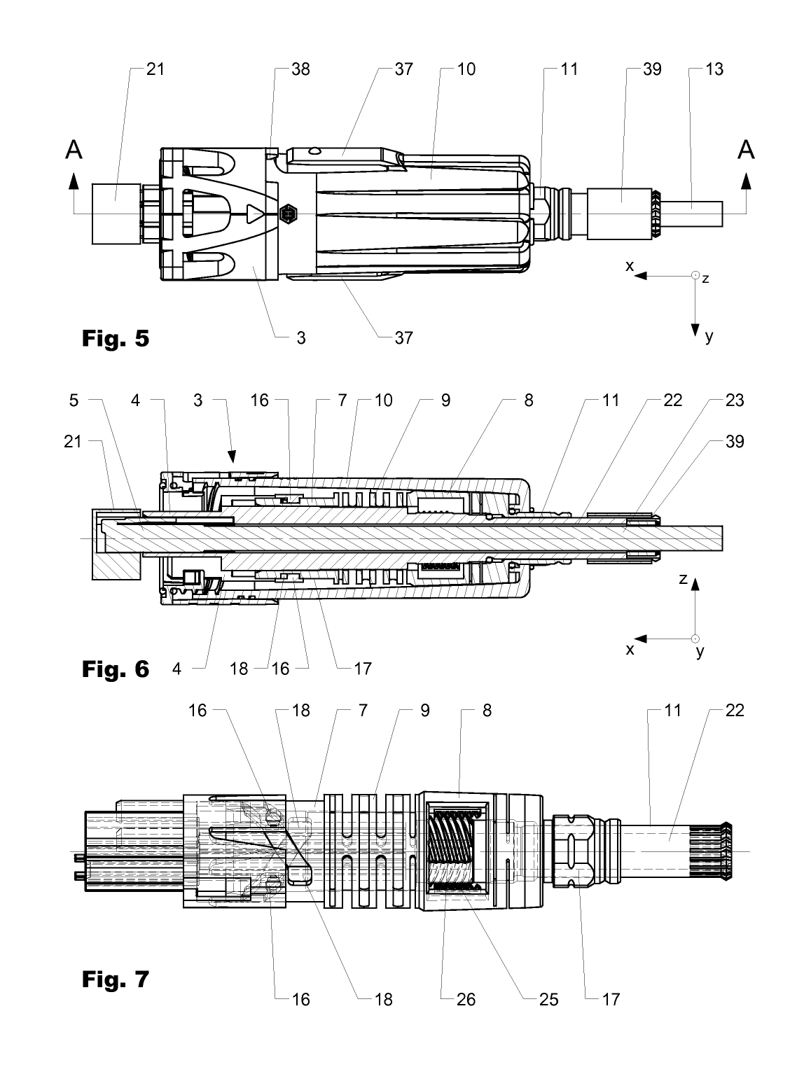

FIG. 1 shows a perspective illustration at an angle from behind and above of an interface connector 1 according to the invention having a plug part 2 and a socket 3. FIG. 2 shows a perspective illustration at an angle from the front and above of the interface connector 1, that is to say the plug part 2 and the socket 3. The connector parts 2, 3 are not illustrated in the operatively connected state. FIG. 3 shows the cable-side plug part 2 (first connector part) and the socket 3 (second connector part) in the longitudinal direction (x-direction) in a disassembled state. FIG. 4 illustrates the first and second connector parts 2, 3 at an angle from behind and above. The connector parts 2, 3 are operatively connected in part. A locking sleeve 10 and the socket 3 are illustrated in section so that the inner parts of the interface connector 1 can be seen. The locking sleeve 10 is not yet locked to the socket 3. FIG. 5 shows the interface connector 1 in plan view and FIG. 6 shows the interface connector 1 in a sectional illustration taken along the line of section AA according to FIG. 5. FIG. 7 shows the inner workings of the interface connector 1 in a plan view. The covered lines are illustrated in a dashed manner. Like reference signs are used in all figures for corresponding parts.

As can be seen in FIGS. 2 and 3, the cable-side plug part 2 has, in its interior, a holder 4 for receiving one or more internal connectors 5 (henceforth connectors). In the embodiment shown, the internal connectors 5 are inserted into the holder 4 from the front (front end). If necessary, they can also be integrated fixedly in the holder 4 or operatively connected to the holder 4 in a different manner. For example, the holder may be formed such that the internal connectors 5 are inserted from the side. Alternatively or in addition, the holder 4 may also be designed in a number of parts. The holder 4 may be used as an adapter for different connectors 5 and, where necessary, can be designed so as to be exchangeable.

### DETAILED DESCRIPTION OF THE INVENTION

The holder 4 is operatively connected to a control part 6 in two ways. The control part 6 is formed in one piece in the embodiment shown and has a front part 7 and a rear part 8, which are operatively connected to one another via a spring 9. In the embodiment shown, the control part 6 is manufactured from plastic by injection molding and in the longitudinal direction has a continuous opening in which the holder 4 is arranged coaxially. If necessary, the control part 6 may also be designed in a number of parts. The rear part 8 has an outer square 17, which interlocks with an inner square 18 of the locking sleeve 10 in the assembled state so as to be locked against rotation.

The spring 9 is formed resiliently in the axial direction (x-direction) and is used in the embodiment shown to resiliently support the front part 7 with respect to the stationary rear part 8 and also to transfer a rotational movement about the x-axis from the rear part 8, or the locking sleeve 10, to the front part 7. For this reason, the spring is sufficiently torsionally rigid. If necessary, the rotational movement can also be transferred in another way from the locking sleeve 10 to the front part 7, for example by a positive fit between a groove and a pin of corresponding design (neither of which is illustrated in this case).

The holder 4 has an internal shaft 11, which, in the embodiment shown, runs within the control part 6. When the plug part 2 is screwed into the socket 3, the holder 4 is aligned with respect to the socket 3 by centering means such that a connector 5 inserted into the holder 4 or integrated therein can be operatively connected to a connector counterpiece 21 on the socket side. The holder 4 has a continuous opening 22 in the longitudinal direction, said opening being used to receive a cable 23 of the at least one connector 5.

At the front end 12, the shaft 11 of the holder 4 transitions into an end plate 13 and an outer part 14 molded thereon, which surrounds the shaft 11 concentrically and over regions at a defined distance (gap 27) in a manner adjoining the front end 12 and directed to the rear (x-direction). In the assembled state, the front part 7 of the control part 6 engages in the gap 27. In this position, the outer part 14 is operatively connected to the front part 7 of the control part 6 via a first operative connection path, since inwardly directed control pins 16 on the outer part 14 engage in the guide groove 18 at an outer face 17 of the front part 7 (see FIG. 7).

The locking sleeve 10 has a specially designed fastening thread 28 on the outer side. This thread has a plurality of thread pieces 29 having different start points. These are arranged over an outer face 30 of the locking sleeve 10 in such a way that the plug part 2 can only be fitted into the socket 3 in a defined position. The socket 3 has countermeans 34 of corresponding design for operative connection of the fastening thread 28 to an inner face 31 of a sleeve 33 of the socket 3 protruding from a base plate 32. The thread pieces 29 have a first axially extending portion 35, which transitions at the rear end into a substantially tangentially extending portion 36. The tangentially extending thread portions 36 have the same pitch in the embodiment shown as the segmented thread 24. If necessary, further fastening elements can be provided. Tongue-like latching elements 37 are formed on the locking sleeve 10 and, in an end position, latch into recesses 38 in the socket 3 provided for this purpose and therefore prevent undesired rotation of the locking sleeve 10.

When the locking sleeve 10 is screwed into the socket 3 in a clockwise direction, the rotation of the locking sleeve 10 is transferred via the square 19, 20 to the rear part 8 of the control part 6 and from here to the front part 7 via the spring 9. Due to the operative connection between the control pin 16 and the guide groove 18 (first operative connection path), the holder 4 moves forward in the direction of the socket 3 as a result of the rotation so that the internal connectors 5 are slid into the connector counterpiece 21 as far as a stop. Once the internal connectors 5 have reached the stop, the spring 9 is tensioned.

In order to avoid possible problems with relatively long periods of operation, the connector according to the invention has a second operative connection path between the holder 4 and the locking sleeve, or the rear part 8 of the control part 6. As a result of this second operative connection path, the spring 9 is relieved once the correct end position of the internal connector 3 has been reached. At the same time, the internal connector is fixed with respect to the connector counterpiece 21. Since the first operative connection path is suitable for correct positioning and compensation of tolerances, the second operative connection path is used for correct positioning of the at least one internal connector 3 with respect to the connector counterpiece 21 associated therewith.

In the embodiment shown, the second operative connection path is formed by a segmented thread connection 24 (see FIG. 4) acting between the holder 4 and the rear part 7. This thread connection consists of a segmented inner thread 25, which is molded on the rear part 7 and cooperates with a segmented outer thread 26 formed on the shaft 11 of the holder 4 to form the second operative connection path. Segmentation is implemented in the peripheral direction and causes the thread to engage only after a specific angle of rotation. Before the segmented thread connection 24 engages, the holder 4 may be displaced in the longitudinal direction (x-direction) over the first operative connection path (control pin 16 and guide groove 18) against the force of the spring 9, and the internal connectors 5 may thus be positioned. The device is designed such that the first operative connection path is functionally released by the second operative connection path once the internal connectors 5 have reached the correct end position.

Illustrated in a simplified manner, in the embodiment shown the retaining forces between the internal connector 5 and the connector counterpiece 21 are transferred in the assembled state from the holder 4 via the segmented thread (second adjuster) 24 to the locking sleeve 10, and from there via the socket 3.

Depending on the field of application, other load paths may also be used, either alternatively or in addition. It is also possible for the first and second adjusters 15, 24 to have different load paths and/or activation paths. For example, the plug part 2 can be designed such that the holder 4 is supported directly at the socket 3 in the assembled state and is still pushed forward by a first adjuster by rotation of the locking sleeve 10. For example, the socket 3 may have one or more rows of latching teeth (not shown) for this purpose, which cooperate with corresponding countermeans (not illustrated) formed on the holder 4 or operatively connected thereto. For example, resiliently protruding latching arms that latch into one or more latching teeth in one or more defined positions when the holder 4 is axially displaced and that, for example, can be unlocked again by pulling back a release element can be used as countermeans. The countermeans may be self-locking and/or externally actuatable. The load path can be shortened by support of the holder 4 with respect to the socket 3. In one embodiment, the holder 4 has one or more laterally protruding latching arms, which project rearward and upward and are designed such that they are suitable for latching into latching teeth provided for this purpose in the region of the inner face 31 of the socket 3. If necessary, additional guide elements can be provided that align the holder 4 with respect to the socket 3. Since the holder 4 is pushed forward to slide the internal connector 5 into the connector counterpiece 21, the latching arms start to latch into the latching teeth in one or more positions. The holder 4 is held so as to be rigidly fixed in this position with a specific load level, or at least one direction. If necessary, additional stops can be provided, which prevent undesired shifting of the holder 4. To unlock the latching arms, a release element can be drawn back by means of the holder 4 or another adjuster. This acts directly on the latching arms and unlocks it so that the holder 4 can be removed.

The shaft 11 has a cable entry 39 at the rear end, said cable entry being used to fasten the cable 23 with respect to the shaft 11. The cable entry 39 may be a crimped or screwed version. Different seals 40 in the form of O-rings are arranged between the locking sleeve 10, the socket 3 and the shaft 4 and protect the inner workings of the device against external influences. Other embodiments are possible.

In the embodiment shown, at the front end the holder 4 has an elongate groove 41, which interlocks with a protruding guide pin 42 when fitted into the socket 3 and thus prevents undesired rotation of the holder 4 with respect to the socket 3.

1. An interface connector (1) comprising:
a socket (3);
a plug part (2) mechanically operatively connected to the socket (3) via a locking sleeve (10);
a holder (4) for receiving at least one internal connector (5), wherein the holder (4) is arranged displaceably with respect to the locking sleeve (10) and is operatively connected thereto via a first adjuster (15) and a second adjuster in such a way that, when the plug part (2) is mechanically operatively connected to the socket (3), the internal connector (5) is first positioned by the first adjuster (15) with respect to a connector counterpiece (21) arranged on the socket (3) and, once a defined end position has been reached, is fixed with respect to the connector counterpiece (21) by the second adjuster (24).

2. The interface connector (1) as claimed in claim 1, wherein the first adjuster (15) produces a mechanical operative connection between the locking sleeve (10) and the holder (4) and comprises at least one control pin (16), which engages in a guide groove (18) to displace the holder (4) in the direction of an axis of rotation relative to the locking sleeve (10) by rotating the locking sleeve (10) about the axis of rotation.

3. The interface connector (1) as claimed in claim 2, wherein the guide groove (18) comprises a plurality of segments.

4. The interface connector (1) as claimed in claim 3, wherein the guide groove (18) is approximately V-shaped.

5. The interface connector (1) as claimed in claim 1, wherein the second adjuster (24) comprises a segmented inner thread (25) and a segmented outer thread (26), which engage in one another in mechanical operative connection to fix the holder (4) with respect to the socket (3).

6. The interface connector (1) as claimed in claim 1, wherein the holder (4) is supported at the locking sleeve (10) and/or at the socket (3) in the assembled state.

7. The interface connector (1) as claimed in claim 6, wherein the holder (4) includes at least one latching arm, which is suitable for latching into corresponding latching teeth on the socket (3).

8. The interface connector (1) as claimed in claim 1, further comprising a spring (9) arranged between the holder (4) and the locking sleeve (10) so that the holder (4) is displaceable against the force of the spring (9).

9. The interface connector (1) as claimed in claim 8, wherein the first adjuster (15) relieves the spring (9) once the locking sleeve (10) is assembled on the socket (3).

10. The interface connector (1) as claimed in claim 8, wherein the spring (9) transfers the rotation of the locking sleeve (10) to a front part, which is used to displace the holder (4) in the axial direction.

11. The interface connector (1) as claimed in claim 1, wherein the at least one internal connector (5) is integrated in the holder (4).

12. The interface connector (1) as claimed in claim 1, wherein the locking sleeve (10) includes a fastening thread (28), by means of which it can be operatively connected to the socket (3).

13. The interface connector (1) as claimed in claim 12, wherein the fastening thread (28) includes the same pitch as the segmented thread (24).

14. The interface connector (1) as claimed in claim 1, wherein the at least one internal connector (5) comprises one of an optical connector and an electrical connector.
